(19) United States
(12) Patent Application Publication
(10) Pub. No.: US 2011/0168016 A1
(43) Pub. Date: Jul. 14, 2011

(54) ASSEMBLED PISTON

(76) Inventors: Achim Fedyna, Bundesland (DE); Gottfried Schnaitmann, Backnang (DE)

(21) Appl. No.: 12/671,614

(22) PCT Filed: Jul. 24, 2008
(86) PCT No.: PCT/EP2008/059699

§ 371 Date: Feb. 10, 2011

(30) Foreign Application Priority Data
Aug. 2, 2007 (DE) 10 2007 036 236.8

(51) Int. Cl. F16J 1/00

(52) U.S. Cl. 92/255

(57) ABSTRACT

An assembled two-part piston, comprising: a piston upper part and a piston lower part, wherein a screw thread connects the piston upper part to the piston lower part.

The present invention relates to an assembled, in particular two-part pistons or an internal combustion engine having a piston upper part and a piston lower part according to the preamble of claim 1.

In internal combustion engines subject to high thermal and mechanical stresses, steel is frequently used as a piston material owing to its high degree of heat resistance. Because of high thermal stresses, such pistons almost always exhibit a cooling canal structure through which cooling medium, motor oil in particular, is conducted in order to cool the pistons during the operation of the internal combustion engine.

Different manufacturing methods for such pistons having cooling canal structures are conceivable. First, it is possible to design such a piston as having one part, generally requiring that a blank be forged, after which all contours are machined. The cooling canal in such an instance must be configured so as to run circumferentially in a piston lower part and for manufacturing-specific reasons must be open toward the piston upper part, which makes it necessary to install an additional element, such as a cover plate, in order to seal the open cooling canal structure.

Secondly, such pistons can be configured as having two parts, a piston upper part and a piston lower part that are manufactured separately in a forging process. This variant is advantageous in that a cooling canal can be closed directly through the geometric shape of the piston upper part and piston lower part. However, it is disadvantageous in that subsequent to the closing of the cooling canal, a machining of the joint location is not excluded. Should a welding process, for example, be used as a joining method, during which high heat input from the welding process leads to a melting of the joint location that thereby brings about a joining, it is possible that a weld results from said joining, which weld can form a bead. This bead cannot be subsequently removed and can possibly negatively affect the cooling medium flow and thereby the cooling effect as well.

A piston of the generic type in question is disclosed in, for example, document DE 102 09 168 B4 and document DE 41 34 530 C2.

The present invention addresses the problem of providing an improved embodiment for a piston of the generic type in question that, in particular, dispenses with the disadvantages known from the prior art such as, for example, the weld having a bead that negatively affects the cooling effect.

This problem is solved according to the invention by the subject matter of the independent claim 1. Advantageous embodiments of the invention are the subject matter of the dependent claims.

The invention is based on the general concept of joining a piston upper part and a piston lower part of a piston constructed of two parts by means of a screw thread, that is to say by screwing the parts together. The piston upper part comprises together with the piston lower part a cooling canal or a cooling canal structure, the cooling canal or the cooling canal structure being tightly sealed subsequent to screwing both of the piston parts to one another. A subsequent welding process, in particular, that would lead to the above-mentioned welds with the known disadvantages, can hereby be dispensed with so that a cooling medium flow in the cooling canal or in the cooling canal structure and accordingly also the cooling effect is no longer negatively affected by such a bead. It goes without saying that the screw thread is configured as airtight with respect to the cooling medium. Steel, for example, comes into consideration as a material for a piston constructed in such a manner because steel exhibits a high degree of heat resistance.

The piston upper part and the piston lower part are advantageously manufactured from the same material or at least have materials having the same thermal expansion coefficients. This offers the considerable advantage that the materials and accordingly the piston lower part and the piston upper part always expand uniformly as a function of temperature in such a manner that there is no risk of the weld between piston upper part and piston lower part opening owing to different coefficients of thermal expansion of both of the piston parts, which would cause the cooling canal structure or the cooling canal to become unsealed.

In another advantageous embodiment of the solution according to the invention, a screw thread on the piston upper part and/or on the piston lower part is manufactured as oversized and both pistons are joined to each other by means of a thermal joining process. A screwing together of both of the piston parts is possible here only if at least one of both of the piston parts is heated or cooled and can be screwed onto the screw thread of the other piston owing to thermal expansion or thermal contraction. By means of a subsequent cooling or heating process, the screw thread of the one piston part shrinks on the screw thread of the other piston part, thereby becoming sealed in a gas-tight manner. Additional, in particular costly, sealing procedures are thus no longer necessary.

Alternatively, the piston according to the invention can have a fine pitch thread that is sealed by an adhering or soldering process that follows the screwing together. In this joining process, a thermal heating or cooling process is dispensed with and the sealing of the screw thread is effected merely by its geometric configuration as a fine pitch thread that is subsequently sealed by means of adhering or soldering. In this manner, it is possible to dispense with a heating or cooling device for thermal joining.

Additional important features and advantages of the invention can be found in the dependent claims, in the drawings, and in the pertinent description of the figures with reference to the drawings.

It is understood that the features described above and those to be described in what follows can be used not only in the particular cited combination, but also in other combinations or independently without departing from the scope of the present invention.

Preferred embodiments of the invention are shown in the drawings and are described in more detail in the following description, the same reference numerals referring to components which are the same or functionally the same or similar.

It is schematically shown respectively in

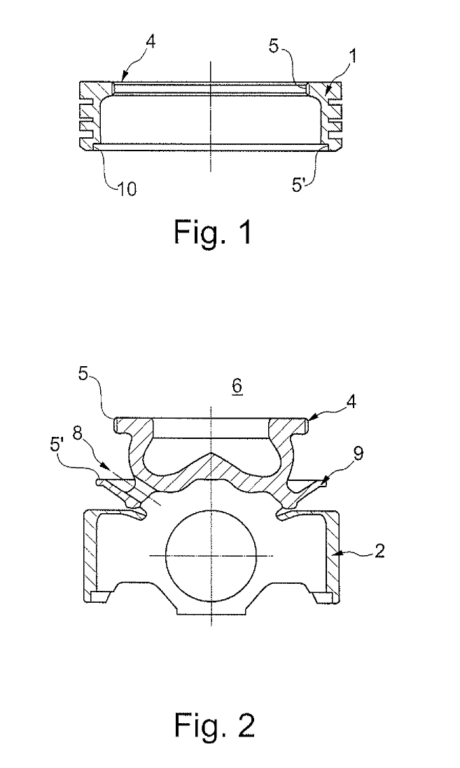

FIG. 1 a piston upper part of an assembled piston according to the invention,

FIG. 2 a piston lower part of the assembled piston,

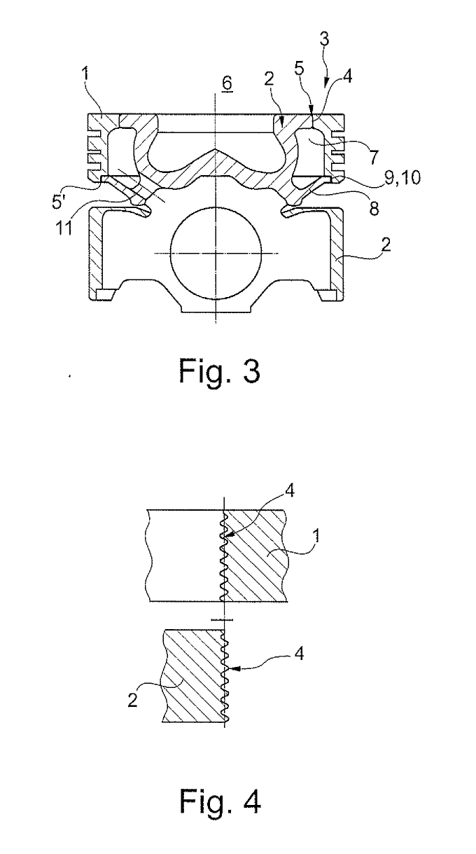

FIG. 3 a completely erected piston,

FIG. 4 a detail view of a screw thread between piston upper part and piston lower part.

Corresponding to FIG. 1, a piston upper part 1 of a piston 3 is shown (cf. FIG. 3), which piston is assembled out of said upper part and a piston lower part 2 (cf. FIG. 2). The piston 3 can be arranged in an internal combustion engine, which is not shown here, in particular in a motor vehicle. Both of the piston parts 1 and 2 are connected to each other by means of a screw thread 4 by means of which further joining methods in particular, such as welding, for example, are rendered superfluous.

According to FIG. 1, the screw thread 4 of the piston upper part 1 is configured as an internal screw thread, while the screw thread 4 of the piston lower part 2 according to FIG. 2 is configured as an external screw thread complementary thereto. A joint location 5 between piston lower part 1 and piston upper part 2 thus results in the region of the screw thread 4, said joint location being in direct contact with a combustion chamber 6 of the internal combustion engine. For this reason, the joint location 5, that is to say the screw thread 4, must be configured as gas-tight, in particular sealed with regard to blow-by gases.

As can be seen in FIG. 3, in the state in which the piston upper part 1 and the piston lower part 2 are screwed together, they incorporate a cooling canal 7 or a cooling canal structure, said cooling canal 7 being positioned annularly around an upper part of the piston lower part 2. In order to cool the piston 3, the cooling canal 7 is impinged upon with a cooling medium, in particular with motor oil, that flows through it as well, all of which occurs during the operation of the internal combustion engine. It is understood that the screw thread 4 must also be configured as sealed with regard to the cooling medium, that is to say sealed with respect to motor oil, for example.

As can be seen in FIGS. 2 and 3, a collar 8 is arranged on the piston lower part 2, which collar has an annular sealing edge 9. In contrast thereto, the piston upper part 1 has a sealing contour 10, in particular a sealing groove, opposite the sealing edge 9 of the lower piston part 2, in/on which sealing contour said sealing edge 9 sealingly rests subsequent to the piston upper part and piston lower part 1, 2 having been completely screwed together. Yet another joint location 5′ between the piston upper part 1 and the piston lower part 2 is thus sealed upon complete assembly of the piston 3. In order to impinge the cooling canal 7 with a cooling medium, a through hole 11, in particular a bore hole, can be provided in the piston lower part 2, said through hole connecting the cooling canal 7 to a cooling circuit.

In order to be able to tightly seal the joint location 5 in particular, an oversized screw thread 4 can be manufactured on the piston upper part 1 and/or on the piston lower part 2 and both of the piston parts 1 and 2 can be screwed to one another by means of a thermal joining process. To this end, the piston upper part 1 is, for example, heated and, when still in the heated state, screwed onto the piston lower part 2. The piston upper part 1 shrinks after it cools, thereby making it possible for a sealed thermal joint seat to be achieved. The same effect can be achieved by, for example, a cooling of the piston lower part 2, which cooling brings about the shrinking of said piston lower part, thereby making is possible for said piston to be screwed together with the piston upper part 1. With a subsequent heating of the piston lower part 2, it expands, thus likewise forming a sealed thermal joint seat with the piston upper part 1.

It can also be provided as an alternative to thermal joining to configure the screw thread 4 as a fine pitch thread and by means of an adhering or soldering process occurring subsequent to the screwing together of both said piston parts, a seal is thereby produced. In this method, both of the piston parts 1 and 2 are screwed to one another while in a cold state, the gas tightness being generated by the above-mentioned subsequent welding or adhering of the screw thread 4. In comparison with the joining methods known from the prior art, for example welding, both methods offer the considerable advantage that no weld seam bead results that protrudes into the cooling canal 7, disrupting the flow of the cooling medium.

Such a screw thread 4 between the piston upper part 1 and the piston lower part 2 furthermore makes possible a very precise alignment of both of the piston parts 1 and 2 to one another in such a manner that many regions of both of the piston parts 1 and 2 can already be configured as completely machined prior to the joining of both said piston parts to one another. After the joining, only those regions of the piston parts 1 and 2 require post processing that are directly involved with tolerance indications such as, for example, right angularity or parallelism.

Since very high temperatures can arise in an internal combustion engine, is it important that an optionally occurring heat expansion does not lead to an opening of the joint location 5 or 5′. Therefore, the piston upper part 1 and the piston lower part 2 are preferably manufactured from the same material or at least from materials having the same coefficients of heat expansion. This ensures the leak tightness of the joint locations 5 and 5′ for the temperature ranges in question.

According to FIG. 4, yet another detail representation of the screw thread 4 on the piston upper part 1 and on the piston lower part 2 is shown in conclusion, the state of being oversized being visible, that is to say an overlap of the screw thread diameter of both of the screw threads 4 is visible.

1. An assembled two-part piston, comprising: a piston upper part and a piston lower part, wherein a screw thread connects the piston upper part to the piston lower part.

2. The piston as specified in claim 1, wherein a joint location between the piston upper part and the piston lower part is in direct contact with a combustion chamber of an internal combustion engine, wherein the screw thread is configured to be gas tight, such that the screw thread is sealed against blow-by gases.

3. The piston as specified in claim 1, wherein the piston upper part and the piston lower part incorporate a cooling canal when they are screwed together.

4. The piston as specified in claim 1, wherein the piston upper part and the piston lower part are manufactured out of at least one of the same material and out of materials having the same coefficients of thermal expansion.

5. The piston as specified in claim 1, wherein a screw thread on at least one of the piston upper part and on the piston lower part is oversized, and the piston upper part and the piston lower part are screwed to each other by thermal joining.

6. The piston as specified in claim 1, wherein the screw thread is a fine pitch thread, and the screw thread is sealed by at least one of an adhering and soldering subsequent to screwing together.

7. The piston as specified in claim 1, wherein a collar is arranged on the piston lower part, wherein the collar has an annular sealing edge.

8. The piston as specified in claim 7, wherein the piston upper part has a sealing contour opposite the sealing edge of the lower piston part, wherein the sealing edge sealingly rests when the piston upper part and piston lower part are completely screwed together.

9. (canceled)

10. The piston as specified in claim 2, wherein the piston upper part and the piston lower part incorporate a cooling canal when they are screwed together.

11. The piston as specified in claim 2, wherein the piston upper part and the piston lower part are manufactured out of at least one of the same material and out of materials having the same coefficients of thermal expansion.

12. The piston as specified in claim 3, wherein the piston upper part and the piston lower part are manufactured out of at least one of the same material and out of materials having the same coefficients of thermal expansion.

13. The piston as specified in claim 2, wherein a screw thread on at least one of the piston upper part and on the piston lower part is oversized, and the piston upper part and the piston lower part are screwed to each other by thermal joining.

14. The piston as specified in claim 3, wherein a screw thread on at least one of the piston upper part and on the piston lower part is oversized, and the piston upper part and the piston lower part are screwed to each other by thermal joining.

15. The piston as specified in claim 4, wherein a screw thread on at least one of the piston upper part and on the piston lower part is oversized, and the piston upper part and the piston lower part are screwed to each other by thermal joining.

16. The piston as specified in claim 2, wherein the screw thread is a fine pitch thread, and the screw thread is sealed by at least one of an adhering and soldering subsequent to screwing together.

17. The piston as specified in claim 3, wherein the screw thread is a fine pitch thread, and the screw thread is sealed by at least one of an adhering and soldering subsequent to screwing together.

18. The piston as specified in claim 4, wherein the screw thread is a fine pitch thread, and the screw thread is sealed by at least one of an adhering and soldering subsequent to screwing together.

19. The piston as specified in claim 2 wherein a collar is arranged on the piston lower part, wherein the collar has an annular sealing edge.

20. The piston as specified in claim 3 wherein a collar is arranged on the piston lower part, wherein the collar has an annular sealing edge.

21. The piston as specified in claim 4 wherein a collar is arranged on the piston lower part, wherein the collar has an annular sealing edge.
